(19) United States
(12) Patent Application Publication
(10) Pub. No.: US 2024/0201351 A1
(43) Pub. Date: Jun. 20, 2024

(54) METHOD TO PROVIDE A TIME-OF-FLIGHT ESTIMATE

(71) Applicant: STMICROELECTRONICS S.r.l., Agrate Brianza (IT)

(72) Inventors: Davide RUGGIERO, S. Agata de Goti (IT); Rosario SCHIANO LO MORIELLO, Bacoli (IT)

(73) Assignee: STMICROELECTRONICS S.r.l., Agrate Brianza (IT)

(21) Appl. No.: 18/532,939

(22) Filed: Dec. 7, 2023

(30) Foreign Application Priority Data
Dec. 16, 2022 (IT) 10202200025848
Dec. 16, 2022 (IT) 102022000025848

(51) Int. Cl. G01S 7/52

(52) U.S. Cl. CPC G01S 7/52025

(57) ABSTRACT

Method to provide a TOF estimate by a TOF device. The method comprises: generating an electric echo signal indicative of an ultrasonic echo signal returned by a target body by the ultrasonic source signal; determining an envelope signal indicative of an envelope of the electric echo signal; generating a first TOF estimate by processing the electric echo signal; determining an envelope signal portion of the envelope signal based on a non-PSOA hyperparameter; and generating a second TOF estimate by processing the envelope signal portion through PSOA, the second TOF estimate having a measurement accuracy value greater than that of the first TOF estimate. PSOA is optimized based on a PSOA hyperparameter set. The non-PSOA hyperparameter and the PSOA hyperparameter set are selected among a plurality of choices based on the first TOF estimate, so as to obtain the second TOF estimate which has greater accuracy than the first TOF estimate.

### BACKGROUND

### Technical Field

The present disclosure relates to a method to provide a time-of-flight (TOF) estimate. In particular, this method allows for a better time-of-flight measurement accuracy. Furthermore, the present disclosure relates to a TOF device, to a system comprising the TOF device and to a related computer program product.

### Description of the Related Art

As known, ultrasound imaging techniques have proven to be a powerful tool to perform distance measurements with high accuracies and at a low cost. Detecting autonomous movable robots in the environment, high-definition imaging of biomedical devices, identifying the precise position of micro-defects in materials, and accurately estimating the level of flammable liquid in a container are examples of applications that require reliable and fast measurements of the distance between a device and an external surface.

Most of the ultrasound imaging techniques are based on the time-of-flight (TOF) estimate, i.e., on the measurement of the time taken by an ultrasonic signal emitted by an ultrasonic transducer device, for example of the MEMS type (“MEMS ultrasonic transducer,” MUT), to travel from the MUT (i.e., from a reference source) to a target body partially reflecting acoustic waves, and vice versa. The distance between the MUT and the target body to be detected is then obtained by means of a time-distance conversion, taking into account the speed of sound in air.

Despite their wide use, these measurement techniques suffer from some problems, for example linked to the detection of the onset of the ultrasonic echo (i.e., the presence of noise and other signals interfering with the echo), the attenuation of amplitude of the echo signal, at the distortion of the shape of the ultrasonic echo and at the sensitivity to temperature and humidity of the propagation speed of the acoustic waves in the propagation means (e.g., air).

The main consequence of these problems is a general degradation of both the distortion of the ultrasonic echo waveform and the experimental standard deviation of the measurement results. Considering negligible the dependence on temperature and humidity of the propagation speed of the acoustic waves in the propagation means (for example, by means of a simultaneous measurement of temperature and humidity, which allow to compensate for these effects), the main problem to be addressed to improve the measurement accuracy is to improve the accuracy of the acquisition of the ultrasonic echo start position, i.e., to obtain precise identification of the echo start time. In fact, the distortions of the measurement noise and the shape of the ultrasonic echo, which generally affect the transmitted signal, make it difficult to correctly identify the start position of the ultrasonic echo.

The presence of noise in the measurement prevents the use of simplistic approaches based on the detection of threshold conditions in order to identify the start time of the ultrasonic echo, while the echo shape distortions cause the measurement results to be influenced by a high difference between the estimated TOF and the actual TOF when a cross-correlation estimator (the optimal estimator according to the maximum likelihood criterion in the case of additive Gaussian white noise) is used.

The use of more complex models (e.g., non-linear Kalman filters) allows to obtain better TOF estimates with respect to the previously discussed techniques, with uncertainties in the distance estimate reaching up to 3 mm. However, these methods are demanding from a computational point of view with respect to other known techniques, such as threshold-based models or cross-correlation estimator (CCE) models.

Furthermore, some applications require a distance estimate that is more accurate than what has been previously discussed (e.g., measurement uncertainties lower than about 3 mm). In this case, solutions based on optical detection techniques are often used, which however require instrumentation that is much more expensive and complex to manage and use than in the case of ultrasound measurement.

The aim of the present disclosure is to provide a method to provide a time-of-flight (TOF) estimate, a TOF device, a system comprising the TOF device and a computer program product, which overcome the drawbacks of the prior art.

### BRIEF SUMMARY

According to the present disclosure, there are provided a method to provide a time-of-flight (TOF) estimate, a TOF device, a system comprising the TOF device and a computer program product.

### BRIEF DESCRIPTION OF THE SEVERAL VIEWS OF THE DRAWINGS

For a better understanding of the present disclosure, a preferred embodiment is now described, purely by way of non-limiting example, with reference to the attached drawings, wherein:

FIG. 1 is a block diagram schematically showing a time-of-flight (TOF) device, according to an embodiment;

FIG. 2 is a graph showing signals, obtained through the TOF device of FIG. 1, and a function that models them, according to an embodiment;

FIG. 3 is a block diagram schematically showing a method to provide a time-of-flight estimate, according to an embodiment;

FIGS. 4A and 4B are block diagrams schematically showing respective methods to determine and update parameters used in the method of FIG. 3, according to respective embodiments; and

FIG. 5 is a block diagram schematically showing a system comprising the TOF device of FIG. 1, according to one embodiment.

In the following description, elements and steps common to the different embodiments have been indicated by the same reference numerals.

### DETAILED DESCRIPTION

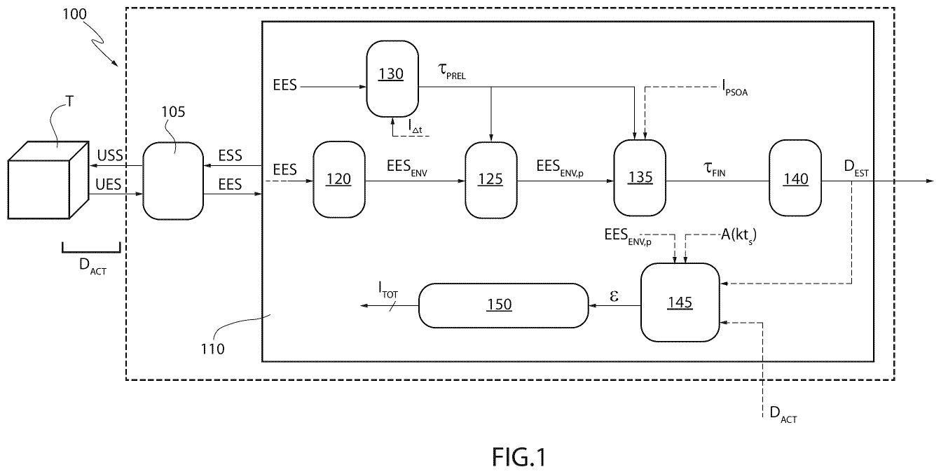

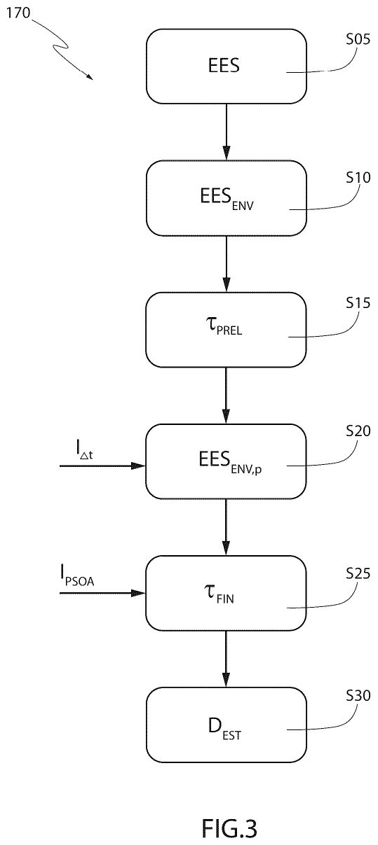

With reference to the drawings, FIG. 1 schematically shows a device (hereinafter, TOF device or, more simply, device) 100 configured to provide an ultrasonic time-of-flight estimate (hereinafter, TOF estimate). The TOF device 100 is configured to implement a method (hereinafter, TOF method) to provide the TOF estimate. The TOF method is shown in FIG. 3 and is indicated by the reference 170.

Elements of the TOF device 100 and steps of the TOF method deemed relevant for the understanding of the present disclosure are shown and discussed hereinbelow, with other known components of the TOF device 100 and known steps of the TOF method which will be intentionally omitted for the sake of conciseness.

In accordance with the per se known principles of the ultrasonic time-of-flight estimate, an ultrasonic signal (hereinafter, ultrasonic source signal) USS is generated and transmitted by the TOF device 100 towards a target body T. The target body T is external, i.e., it is not part of the TOF device 100; the target body T comprises a physical object having a mass, such as a living being (such as a person, an animal, and a tree) or an inanimate object (such as a building or a vehicle). A corresponding ultrasonic signal (hereinafter, ultrasonic echo signal) UES is originated from the target body T by reflection of the ultrasonic source signal USS hitting the target body T. The ultrasonic echo signal UES is received at the TOF device 100 and the TOF estimate is determined, by the TOF device 100, as the time elapsed from the transmission of the ultrasonic source signal USS to the reception of the ultrasonic echo signal UES.

The TOF device 100 is configured to determine, based on the TOF estimate, an estimated distance D_{EST} indicative of an actual distance D_{ACT} between the TOF device 100 and the target body T.

In particular, the TOF device 100 comprises an ultrasonic transducer 105, in particular of the MEMS type (MUT). In detail, the ultrasonic transducer 105 comprises a piezoelectric ultrasonic transducer (pMUT) or a capacitive ultrasonic transducer (cMUT), of a per se known type.

The ultrasonic transducer 105 is configured to transduce an electric source signal ESS (e.g., a pulse width modulated pulse train, i.e., a Pulse Width Modulation train) into the ultrasonic source signal USS, and to transduce the ultrasonic echo signal UES coming from the target body T so as to obtain a corresponding electric echo signal EES.

In particular, the electric source signal ESS and the electric echo signal EES are digital signals. In this case, the ultrasonic transducer 105 comprises for example a conditioning and conversion system (not shown) to obtain, from the electric source signal ESS (digital), an analog ultrasonic source signal to be transduced into the ultrasonic source signal USS, and to obtain the electric echo signal EES (digital) starting from an analog ultrasonic echo signal obtained by transducing the ultrasonic echo signal UES.

Furthermore, the TOF device 100 comprises a processing unit 110 (e.g., a microcontroller and/or a microprocessor) electrically coupled to the ultrasonic transducer 105 to provide it with the electric source signal ESS and to receive the electric echo signal EES therefrom.

Discussed hereinbelow are the modules of the processing unit 110 deemed relevant to the understanding of the present disclosure, with well-known and/or obvious variations of these modules being omitted for the sake of simplicity.

In particular, in use, the processing unit 110 generates the electric source signal ESS and, subsequently, acquires the electric echo signal EES indicative of the TOF and therefore of the relative distance between the TOF device 100 and the target body T. For illustrative and non-limiting purposes, the electric echo signal EES may be acquired at about 400 kHz.

The processing unit 110 comprises a module 120 configured to determine an envelope signal EES_{ENV} indicative of an envelope (e.g., a profile) of the electric echo signal EES (hence of the ultrasonic echo signal UES).

In particular, in order to determine the envelope signal EES_{ENV}, the module 120 is configured to process the electric echo signal EES through the Hilbert transform (for which reason, hereinafter, the module 120 will be referred to as Hilbert module 120). In detail, the Hilbert module 120 calculates the envelope of the electric echo signal EES without operating any decimation or subsampling of the electric echo signal EES, in order to improve the accuracy of the TOF estimate.

The processing unit 110 further comprises a module 130 configured to determine a first TOF estimate (or preliminary TOF estimate) τ_{PREL} as a function of the electric echo signal EES. For this reason, the module 130 is hereinafter referred to as preliminary estimate module 130.

In particular, the preliminary estimate module 130 determines the first TOF estimate τ_{PREL} by processing the electric echo signal EES by means of a threshold-based model or a cross-correlation estimator (CCE) model, of a per se known type. An example of a threshold-based model may be found in the document Arun T. Vemuri. “Using a fixed threshold in ultrasonic distance-ranging automotive applications,” Amplifiers: Op Amps, Texas Instruments Incorporated, Analog Applications Journal, 3Q 2012 and an example of a cross-correlation estimator model may be found in the document Marioli, D., Narduzzi, C., Offelli, C., Petri, D., Sardini, E., & Taroni, A. (1992). Digital time-of-flight measurement for ultrasonic sensors. IEEE Transactions on Instrumentation and Measurement, 41(1), 93-97.

The first TOF estimate τ_{PREL} has a reduced accuracy (e.g., corresponding to an uncertainty in the estimated distance D_{EST} greater than about 3 mm) but requires reduced timings and computational resources to be performed; as a result, the first TOF estimate τ_{PREL} represents a fast and low-accuracy TOF estimate.

The processing unit 110 further comprises a module 125 to determine a portion of the envelope signal EES_{ENV} (for which reason, hereinafter, the module 125 will be referred to as portion module 125 and the portion of the envelope signal EES_{ENV} will be referred to as envelope signal portion EES_{ENV,p}), as a function of the envelope signal EES_{ENV} and the first TOF estimate τ_{PREL}.

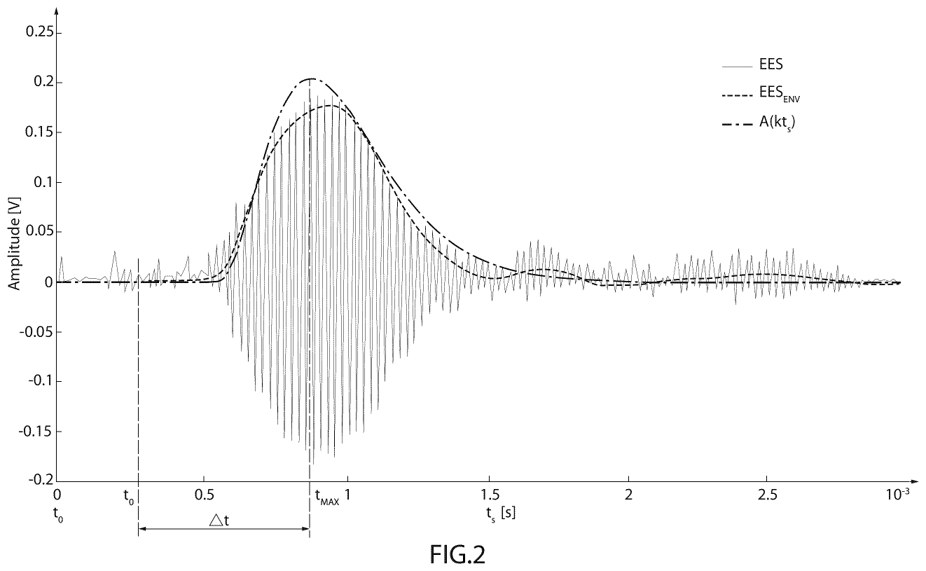

In particular, the envelope signal portion EES_{ENV,p} comprises a portion of the envelope signal EES_{ENV} to the left of a maximum value of the envelope signal EES_{ENV}, i.e., comprises a portion (also called left portion of the envelope signal EES_{ENV}) of the envelope signal EES_{ENV} comprised between an initial time instant to (FIG. 2) of the envelope signal EES_{ENV} and a final time instant t_{MAX} (FIG. 2). The final time instant t_{MAX} corresponds to the maximum of the envelope signal EES_{ENV}, while the initial time instant to is the time instant (prior to the final time instant t_{MAX}) which is temporally distant from the final time instant t_{MAX} by a predefined time period Δt. In other words, t₀=t_{MAX}−Δt, where Δt is the time duration of the envelope signal portion EES_{ENV,p} and is better described hereinbelow. In greater detail, the predefined time period Δt is chosen, as a function of the first TOF estimate τ_{PREL}, among a plurality of predefined time periods Δt determined as better discussed below.

In greater detail, the portion module 125 is configured to select, as a function of the first TOF estimate τ_{PREL}, the predefined time period Δt among the plurality of predefined time periods Δt available, determine the maximum value of the envelope signal EES_{ENV}, calculate the initial time instant t0 as t₀=t_{MAX}−Δt and extract, from the envelope signal EES_{ENV}, the envelope signal portion EES_{ENV,p} comprised between the initial time instant to and the final time instant t_{MAX}.

The processing unit 110 further comprises a module 135 configured to determine a second TOF estimate (or final TOF estimate) τ_{FIN} as a function of the envelope signal portion EES_{ENV,p} and the first TOF estimate τ_{PREL}. For this reason, module 135 is hereinafter referred to as final estimate module 135.

In particular, the final estimate module 135 determines the second TOF estimate τ_{FIN} through a Particle Swarm Optimization Algorithm (PSOA), for example as disclosed in the document Kennedy, J., and R. Eberhart, 1995, “Particle Swarm Optimization,” Proceedings of IEEE International Conference on Neural Networks. In particular, the PSOA is of the single target type, as disclosed for example in the following documents: Mezura-Montes, E., and C. A. Coello Coello. “Constraint-handling in nature-inspired numerical optimization: Past, present and future,” Swarm and Evolutionary Computation, 2011, pp. 173-194; and Pedersen, M. E. “Good Parameters for Particle Swarm Optimization.” Luxembourg: Hvass Laboratories, 2010.

PSOA is a computational method that optimizes a problem by iteratively trying to improve a candidate solution with respect to a given quality measurement. PSOA solves a problem by having a population of candidate solutions, called particles, and moving these particles into the search space based on mathematical formulae about particle position and speed. Each particle's movement is affected by its best known local position, but it is also driven towards better known positions in the search space, which are updated when better positions are found by moving other particles.

The main equations of the PSOA are the following:

$$\begin{matrix}{C}_{i , j} = {c}_{1} {r}_{1 , j} ( {p}_{i , j} ( t - 1 ) - {x}_{i , j} ( t - 1 ) ) \\ {S}_{i , j} = {c}_{2} {r}_{2 , j} ( {g}_{i , j} ( t - 1 ) - {x}_{i , j} ( t - 1 ) ) \\ {V}_{i , j} ( t ) = w {V}_{i , j} ( t - 1 ) + {C}_{i , j} + {S}_{i , j} \\ {x}_{i , j} ( t ) = {x}_{i , j} ( t - 1 ) + {V}_{i , j} ( t )\end{matrix}$$

wherein:
p_{i,j} is the best local of the i-th particle;
g_{i,j} is the best global of the i-th particle in the current proximity;
C_{i,j} is the i-th cognitive parameter in the j-dimensional search space;
S_{i,j} is the i-th social parameter in the j-dimensional search space;
V_{i,j}(t) is the speed parameter of the i-th particle in the j-dimensional search space;
x_{i,j}(t) is the position (solution) of the i-th particle in the j-dimensional search space;
r_{1,j}, r_{2,j} are random values uniformly distributed in [0,1];
c₁, c₂ are acceleration coefficients for the social and cognitive components;
w is the inertial weight aimed at judging between exploration and exploitation steps.

PSOA therefore has a multiplicity of PSOA parameters (e.g., c₁, c₂, w, etc.) which are identified by a plurality of PSOA hyperparameters. In detail, the Matlab implementation of the PSOA (available at the link https://it.mathworks.com/help/gads/particleswarm.html#budidgf-options) may be used. This implementation requires the configuration of the PSOA hyperparameter set, which is indicative of a respective multiplicity of PSOA parameters. For example, the PSOA hyperparameters of the PSOA Matlab version are obtained through combination of PSOA parameters and/or are PSOA parameters that vary significantly as a function of factors such as the specific application of the PSOA, environmental conditions of the TOF measurement, etc.

In particular, the PSOA hyperparameter set corresponds to that of the PSOA Matlab implementation, it is indicated in FIG. 1 by the reference IPSOA and comprises the following hyperparameters:
infInertia is the lower limit of the range of adaptive inertia values of the particle swarm (in detail, it is the lower limit of the Matlab parameter InertiaRange);
minNeigh is the minimum dimension of the adaptive neighbor of the particle swarm (hyperparameter which contributes to the definition of the dimension of the particle neighbor and which, for example, is also called in Matlab as MinNeighborsFraction);
SelfAdj is the weighting level of the best position of each particle when adjusting the particle speed of the particle swarm;
SocialAdj is a weight coefficient indicative of the contribution of the best particle in the neighbor considered when adjusting the particle speed of the particle swarm;
NumIter is the number of iterations of the PSOA;
SwarmSize is the size of the particle swarm, i.e., is the total number of particles involved in the PSOA problem.

Specific values of these PSOA hyperparameters make the PSOA optimized to find a second TOF estimate τ_{FIN} in a respective and specific range of TOF estimate (hence, in a respective and specific distance range between the TOF device 100 and the target body T). In other words, each of these PSOA hyperparameters may vary within an own variation range and each combination of the values of the PSOA hyperparameters defines a respective PSOA hyperparameter set which leads the PSOA to have calculation accuracies of the second TOF estimate τ_{FIN} which are variable as a function of the considered distance value between the TOF device 100 and the target body T. Consequently, each range of actual distance D_{ACT} has a respective PSOA hyperparameter set IPSOA which optimizes the operation of the PSOA in determining the second TOF estimate τ_{FIN}.

Furthermore, in addition to the PSOA hyperparameter set IPSOA, a further non-PSOA hyperparameter, indicated in FIG. 1 by the reference I_{Δt}, is also present. The non-PSOA hyperparameter I_{Δt} is also referred to as LowerBoundtPS and is the lower limit of the time range of values of the envelope signal portion EES_{ENV,p} used for the TOF estimate, i.e., it is a parameter indicative of the time length of the envelope signal portion EES_{ENV,p} and coincides with the predefined time period Δt used in the preliminary estimate module 130.

The union of the PSOA hyperparameter set IPSOA and the non-PSOA hyperparameter I_{Δt} corresponds to a total hyperparameter set, indicated in FIG. 1 by the reference I_{TOT}. Each range of actual distance D_{ACT} has a respective total hyperparameter set I_{TOT} which optimizes the determination of the second TOF estimate τ_{FIN} in this range of actual distance D_{ACT}.

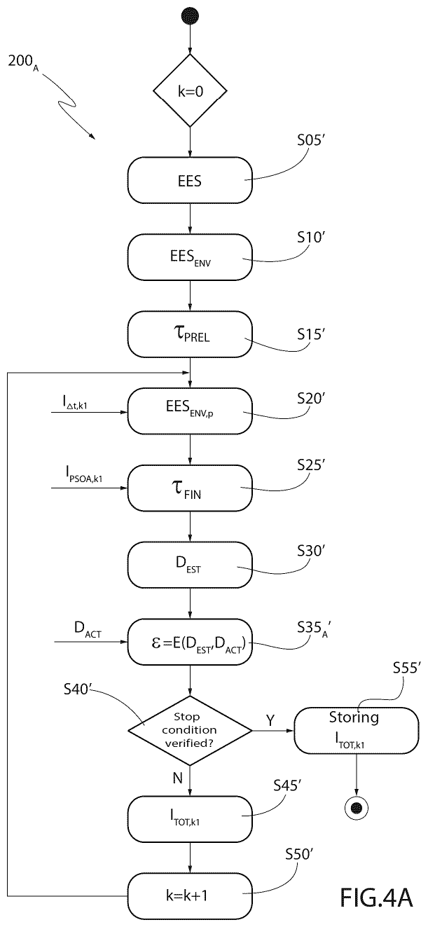

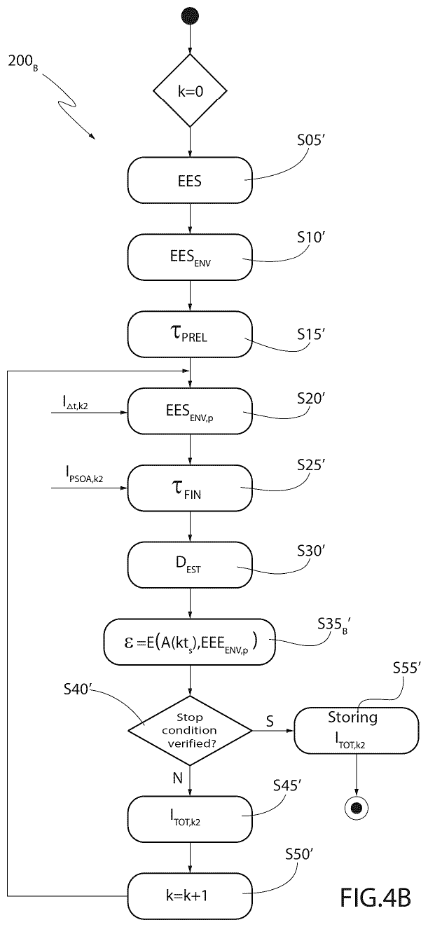

In use, the final estimate module 135 selects, based on the first TOF estimate τ_{PREL} and among a plurality of total hyperparameter sets (determined and updated as better discussed below with reference to FIGS. 4A and 4B), the total hyperparameter set I_{TOT} (and therefore the PSOA hyperparameter set I_{PSOA}) more appropriate for the expected range of estimated distance D_{EST}.

In detail, the final estimate module 135 receives at input the envelope signal portion EES_{ENV,p} and the first TOF estimate τ_{PREL}. Based on the first TOF estimate τ_{PREL} (indicative of a first estimate, not very accurate, of estimated distance D_{EST}), the final estimate module 135 selects a total hyperparameter set I_{TOT} (therefore a PSOA hyperparameter set I_{PSOA}) among a plurality of total hyperparameter sets I_{TOT}. In particular, the selected PSOA hyperparameter set I_{PSOA} optimizes the operation of the PSOA in the range of TOF estimate to which the first TOF estimate τ_{PREL} belongs, therefore it optimizes the PSOA operation in the range of estimated distance D_{EST} to which the estimated distance D_{EST} belongs corresponding to the first TOF estimate τ_{PREL}. Thereafter, the PSOA determines the second TOF estimate τ_{FIN}, based on the selected PSOA hyperparameter set I_{PSOA} and as a function of the envelope signal portion EES_{ENV,p}.

For illustrative and non-limiting purposes, a maximum variation range of estimated distance D_{EST} comprised between about 35 cm and about 190 cm and divided into 31 ranges of estimated distance D_{EST}, having uniform length among them (e.g., about 5 cm), can be considered. A respective PSOA hyperparameter set, which optimize the PSOA in the range considered, is associated with each of these 31 ranges. The first TOF estimate τ_{PREL} allows the optimized PSOA hyperparameter set I_{PSOA} to be selected for the corresponding range of estimated distance D_{EST} (e.g., through a look-up table that associates a respective PSOA hyperparameter set I_{PSOA} with each value of first TOF estimate τ_{PREL}). Subsequently, the PSOA, configured through the selected PSOA hyperparameter set I_{PSOA}, calculates the second TOF estimate τ_{FIN} starting from the envelope signal portion EES_{ENV,p}.

It should be noted that considerations similar to those made for the selection of the PSOA hyperparameter set I_{PSOA} by the final estimate module 135 also apply to the selection of the non-PSOA hyperparameter I_{Δt} by the preliminary estimate module 130.

In greater detail, the determination of the second TOF estimate τ_{FIN} is performed by the PSOA based on the following discrete-time expression which models the envelope of the electric echo signal EES (see, for example, L. Angrisani, A. Baccigalupi, R. Schiano Lo Moriello, “Ultrasonic time-of-flight estimation through unscented Kalman filter,” IEEE Transactions on Instrumentation and Measurement, August 2006):

$$A ( k {t}_{s} ) = {{A}_{0} ( \frac{k {t}_{s} - τ}{T} )}^{α} {e}^{( \frac{{kt}_{s} - τ}{T} )}$$

wherein:
A(kts) is the modeling function of the envelope signal portion EES_{ENV,p};
A0 is the amplitude of the envelope signal portion EES_{ENV,p};
α and T are coefficients which depend, in a per se known manner, on the ultrasonic transducer 105 used, for example a is indicative of the growth slope of the envelope signal portion EES_{ENV,p} before its maximum;
T is the TOF estimate (i.e., the second TOF estimate τ_{FIN});
k is a multiplicative coefficient; and
tₛ is the sampling period (i.e., the time variable).

FIG. 2 shows an example of an envelope model of the electric echo signal EES. In particular, FIG. 2 shows the electric echo signal EES as time varies; FIG. 2 also shows the envelope signal EES_{ENV} and the time instants t=t₀ and t=t_{MAX} which temporally delimit the envelope signal portion EES_{ENV,p} of the envelope signal EES_{ENV}. Furthermore, FIG. 2 shows the modeling function A(ktₛ) which approximates the envelope signal EES_{ENV} (for further description the modeling function A(ktₛ) is shown throughout the time duration of the envelope signal EES_{ENV}, although it is then considered hereinbelow between t=t₀ and t=t_{MAX}).

In other words, the PSOA (optimized with the selected PSOA hyperparameter set I_{PSOA}) models (i.e., approximates) the envelope signal portion EES_{ENV,p} based on this expression, in order to obtain the second TOF estimate τ_{FIN}.

The processing unit 110 may further comprise a module (hereinafter, evaluation module) 140 to determine the estimated distance D_{EST} based on the second TOF estimate τ_{FIN}. This occurs through per se known techniques, for example through standard formulae such as D_{EST}=τ_{FIN}vₛ (with vₛ equal to the speed of sound in air) which may possibly be compensated according to known techniques (e.g., compensation in temperature described for example in L. Angrisani and R. Schiano Lo Moriello, “Estimating ultrasonic time-of-flight through quadrature demodulation,” in IEEE Transactions on Instrumentation and Measurement, vol. 55, no. 1, pp. 54-62, February 2006, doi: 10.1109/TIM.2005.861251 and compensation in temperature, pressure, humidity and CO2 concentration described in The Journal of the Acoustical Society of America 93, 2510 (1993); https://doi.org/10.1121/1.405827, Owen Cramer).

The processing unit 110 may also comprise a module (hereinafter, error module) 145 configured to determine an estimate error F.

According to one embodiment, the estimate error F determined at the error module 145 comprises an absolute error between the estimated distance D_{EST} and the actual distance D_{ACT} existing between the TOF device 100 and the target body T. As will be better understood from the following discussion, this embodiment allows total hyperparameter sets I_{TOT} to be determined iteratively in a preliminary or calibration step of the TOF device 100 (i.e., a step preceding the use of the TOF device 100 as a meter, such as a distance meter). As better discussed hereinbelow, this preliminary or calibration step of the TOF device 100 is obtained through an embodiment of a calibration TOF method (hereinafter also referred to as “offline TOF method” and shown in FIG. 4A), wherein a target body T placed at known actual distances D_{ACT} is used to set the total hyperparameter sets I_{TOT} for later use by the TOF device 100 when used as a meter.

According to a different embodiment, the estimate error P determined at the error module 145 comprises an error (e.g., mean squared error) between the envelope model A(ktₛ) of the electric echo signal EES and the envelope signal portion EES_{ENV,p}, in particular in the time range of the envelope signal portion EES_{ENV,p}. As will be better understood from the following discussion, this embodiment allows the total hyperparameter sets I_{TOT} to be iteratively adjusted and updated in real time while using the TOF device 100 as a meter. As better discussed hereinbelow, this is obtained through an embodiment of the calibration TOF method (hereinafter also referred to as “online TOF method” and shown in FIG. 4B).

In particular, the TOF device 100 may be configured to implement the offline TOF method (in which case the estimated distance D_{EST} and the actual distance D_{ACT} are received from the error module 145), the online TOF method (in which case the model A(ktₛ) and the envelope signal portion EES_{ENV,p} are received by the error module 145), or both the offline TOF method and the online TOF method (e.g., with the online TOF method which may be performed after the offline TOF method): the possibility of implementing the offline TOF method and/or the online TOF method is conceptually represented in FIG. 1 by dashed arrows associated with the estimated distance D_{EST}, the actual distance D_{ACT}, the model A(ktₛ) and the envelope signal portion EES_{ENV,p} at input to the error module 145.

The processing unit 110 may also comprise a module (hereinafter, hyperparameter module) 150 configured to determine the total hyperparameter sets I_{TOT} based on the estimate error ε, as better discussed below with reference to FIGS. 4A and 4B.

In particular, the hyperparameter module 150 implements a Multi-Objective Differential Evolution (MODE) algorithm, disclosed for example in the document H. Monsef, M. Naghashzadegan, A. Jamali, R. Farmani. 2019. “Comparison of evolutionary multi objective optimization algorithms,” Ain Shams Engineering Journal.

Differential evolution (DE) algorithms are methods that optimize a problem by iteratively trying to improve a candidate solution with respect to a given quality measurement. Such methods are commonly known as meta-heuristic methods as they make a small number of assumptions about the optimization of the problem and may search very wide spaces of candidate solutions.

In detail, DE algorithms optimize a problem by maintaining a population of candidate solutions and creating new candidate solutions by combining existing ones according to combination formulae having reduced complexity and maintaining the candidate solution having the best score or suitability on the optimization problem considered. In this manner, DE algorithms may also be used for non-continuous, non-differentiable, noisy and time-variable optimization problems.

In greater detail, the MODE algorithms are based on optimization problems involving simultaneously multiple objective functions to be minimized.

In particular, the hyperparameter module 150 is based on a first objective function f₁ and a second objective function f₂. The first objective function f₁ depends on the error between the estimated distance D_{EST} and the actual distance D_{ACT} or on the error between the model A(ktₛ) and the envelope signal portion EES_{ENV,p}, as better described below. For example, the first objective function fᵢ is equal to one of these errors. The second objective function f₂ depends on (e.g., is equal to) the sum of NumIter and SwarmSize.

The minimization of the objective functions f₁ and f₂ through MODE allows a total hyperparameter set I_{TOT} to be obtained for each range of actual distance D_{ACT}, as better described below.

The total hyperparameter set I_{TOT} forms, for the range of actual distance D_{ACT} considered, one of the solutions of the Pareto front of this multi-objective problem and is optimized for this specific range of estimated distance D_{EST}, as better described below. In detail, the choice between the various candidate solutions of the Pareto front (e.g., six candidate solutions generated by the MODE for each minimization of the objective functions f₁ and f₂) is performed in a predefined manner (e.g., based on a trade-off between measurement accuracy and computational cost, decided during the design step) or by the user of the TOF device 100 (who manually selects the desired trade-off between measurement accuracy and computational cost, among a plurality of available trade-off choices). For example, if greater accuracy (and therefore higher computational cost) is preferred, a solution of the Pareto front will be chosen which favors the minimization of the first objective function f₁; otherwise, if a lower computational cost (and therefore lower accuracy) is preferred, a solution of the Pareto front will be chosen which favors the minimization of the second objective function f₂.

According to the embodiment corresponding to the offline TOF method, the first objective function f₁ is equal to the absolute error between the estimated distance D_{EST} and the actual distance D_{ACT} and the hyperparameter module 150 iteratively varies the total hyperparameters up to achieving their optimization. In detail, the minimization of the first objective function f₁ allows the hyperparameters LowerBoundtPS, infInertia, minNeigh, SelfAdj and SocialAdj to be optimized, while the minimization of the second objective function f₂ allows the hyperparameters NumIter and SwarmSize to be optimized.

According to the embodiment corresponding to the online TOF method, the first objective function fᵢ is equal to the absolute error between the model A(ktₛ) and the envelope signal portion EES_{ENV,p} and the hyperparameter module 150 iteratively varies a subset of the total hyperparameters up to achieving their optimization, keeping the remaining total hyperparameters fixed. In detail, the minimization of the first objective function fᵢ allows the hyperparameters LowerBoundtPS, infInertia to be optimized while the minimization of the second objective function f₂ allows the hyperparameter NumIter to be optimized.

With reference to FIG. 3, the TOF method 170 is now described.

The TOF method 170 comprises acquiring the ultrasonic echo signal UES thus obtaining the corresponding electric echo signal EES (step S05). In particular, the acquisition of the ultrasonic echo signal UES and the generation of the corresponding electric echo signal EES is performed through the conditioning and conversion system of the ultrasonic transducer 105.

The TOF method 170 further comprises determining the envelope signal EES_{ENV} as a function of the electric echo signal EES (step S10). In particular, the envelope signal EES_{ENV} is determined through the Hilbert module 120 of the processing unit 110.

The TOF method 170 further comprises determining the first TOF estimate t_{PREL} as a function of the electric echo signal EES (step S15). In particular, the first estimate TOF τ_{PREL} is determined through the preliminary estimate module 130 of the processing unit 110.

The TOF method 170 further comprises determining the envelope signal portion EES_{ENV,p} based on the envelope signal EES_{ENV} and the first TOF estimate t_{PREL} (step S20). In particular, the envelope signal portion EES_{ENV,p} is determined through the portion module 125 of the processing unit 110.

In greater detail, in step S20, the total hyperparameter set I_{TOT} is selected, as a function of the first TOF estimate t_{PREL} (e.g., through the look-up table), among the total hyperparameter sets I_{TOT} and, based on the selected non-PSOA hyperparameter I_{Δt}, the envelope signal portion EES_{ENV,p} is determined starting from the envelope signal EES_{ENV}.

The TOF method 170 further comprises determining the second TOF estimate τ_{FIN} as a function of the envelope signal portion EES_{ENV,p}, the first TOF estimate τ_{PREL} and the total hyperparameter sets I_{TOT} determined through the offline TOF method and/or the online TOF method (step S25). In particular, the second TOF estimate τ_{FIN} is determined through the final estimate module 135 of the processing unit 110.

In greater detail, in step S25, the total hyperparameter set I_{TOT} is selected, as a function of the first TOF estimate τ_{PREL} (e.g., through the look-up table), among the total hyperparameter sets I_{TOT}, the PSOA is configured (i.e., optimized) based on the selected PSOA hyperparameter set I_{PSOA} and, by means of the optimized PSOA, the second TOF estimate τ_{FIN} is generated starting from the envelope signal portion EES_{ENV,p}.

The TOF method 170 may further comprise determining the estimated distance D_{EST} as a function of the second TOF estimate τ_{FIN} (step S30). In particular, the estimated distance D_{EST} is determined through the evaluation module 140 of the processing unit 110.

The TOF method 170 may further comprise performing the offline TOF method and/or the online TOF method, respectively in order to determine the PSOA hyperparameter sets I_{PSOA} and to update a part thereof if necessary, as better described below.

With reference to FIG. 4A, the offline TOF method (indicated in the Figure by the reference 200_{A}) is described, which allows the total hyperparameter sets I_{TOT} to be determined in the preliminary or calibration step of the TOF device 100.

In this calibration step, the target body T is placed at an actual distance D_{ACT} from the TOF device 100, which is known. This calibration step may be performed during the design step, wherein the TOF estimate is determined with great accuracy in a supervised manner and with known measurement conditions.

Hereinafter, an iteration of the offline TOF method 200_{A} is described which allows a respective set (or optimized set) of total hyperparameters I_{TOT} to be obtained corresponding to a respective value of actual distance D_{ACT} (belonging to a respective range of actual distance D_{ACT}). This iteration is based on a calibration electric echo signal (also indicated by the reference EES) indicative of a known value of actual distance D_{ACT}. In other words, the calibration electric echo signal EES is indicative of, and is associated with, a respective range of actual distance D_{ACT}.

The offline TOF method 200_{A} may be reiterated a plurality of times, each time using a respective and different calibration electric echo signal EES corresponding to a respective value of actual distance D_{ACT}, to obtain a respective plurality of total hyperparameter sets I_{TOT} corresponding to respective ranges of actual distance D_{ACT}. Each of these total hyperparameter sets I_{TOT} therefore optimizes the PSOA and the determination of the calibration envelope signal portion EES_{ENV,p} in a respective range of actual distance D_{ACT} having the used value of actual distance D_{ACT} belonging thereto. In this manner total hyperparameter sets I_{TOT} may be determined which make the PSOA and the determination of the calibration envelope signal portion EES_{ENV,p} optimized throughout the maximum variation range of the estimated distance D_{EST}.

For example, considering the actual distance D_{ACT} variable between about 35 cm and about 190 cm, 31 values of actual distance D_{ACT} equally-spaced from each other may be considered, which define respective ranges of actual distance D_{ACT} having mutual uniform length (e.g., about 5 cm each) and each comprising a respective value of actual distance D_{ACT} considered (e.g., each range is centered in the respective value of actual distance D_{ACT} considered). In this manner 31 total hyperparameter sets I_{TOT} will be determined, among which it will be possible to choose at steps S20 and S25 based on the first TOF estimate τ_{PREL}.

In detail, at each iteration and therefore for each known actual distance D_{ACT}, the offline TOF method 200_{A} comprises performing sub-iterations (indicated by the index k in FIG. 4A).

At the first sub-iteration k=0 of the iteration considered, steps similar to steps S05-S30 are performed (which are therefore indicated here by the new references S05′-S30′ and are not described again in detail for the sake of brevity). Steps S05′-S30′ are performed to determine a first value of calibration estimated distance (also indicated by the reference) D_{EST}. In particular, at step S05′ a calibration dataset is acquired comprising the calibration electric echo signals EES and the corresponding values of actual distance D_{ACT}.

At the first sub-iteration k=0 of each iteration, step S20′ is performed using a preliminary non-PSOA hyperparameter I_{Δt} which has a random or predefined and default value, for example determined on the manufacturer side (e.g., based on the designer's experience) and, similarly, step S25′ is performed using a preliminary PSOA hyperparameter set I_{PSOA} which have random or predefined and default values, for example determined on the manufacturer side (e.g., based on the designer's experience).

The offline TOF method 200_{A} further comprises determining the estimate error F as the absolute error between the calibration estimated distance D_{EST} calculated at the k-th sub-iteration and the actual distance D_{ACT} considered (step S35A′). In particular, the estimate error F is determined through the error module 140 of the processing unit 110.

The offline TOF method 200_{A} further comprises verifying a stop condition (step S40′). The stop condition comprises verifying whether the estimate error F calculated at the k-th sub-iteration is lower than a threshold estimate error ε_{TH} or whether the k number of sub-iterations performed is greater than a sub-iterations threshold number. For purely illustrative and non-limiting purposes, the threshold estimate error ε_{TH} is for example equal to about 1·10⁻¹⁰ and the sub-iterations threshold number is, for example, equal to about 50 iterations.

If the stop condition is not confirmed (i.e., if the estimate error F is greater than, or equal to, the threshold estimate error ε_{TH} and if the k number of sub-iterations performed is lower than, or equal to, the sub-iterations threshold number, output branch N of step S40′), a provisional total hyperparameter set I_{TOT} is determined (step S45′), corresponding to the k-th sub-iteration and indicated in FIG. 4A by the reference I_{TOT,k1} (with I_{TOT,k1}=I_{PSOA,k1}+I_{Δt,k1}).

In particular, the provisional total hyperparameter set I_{TOT,k1} is determined through the hyperparameter module 150. The determination of the provisional total hyperparameter set I_{TOT,k1} occurs by minimizing the first objective function f₁ (here given by the absolute error between the calibration estimated distance D_{EST} and the known actual distance D_{ACT}) and the second objective function f₂, through the MODE algorithm. In detail, the use of the MODE in the offline TOF method 200_{A} allows updated values of the hyperparameters LowerBoundtPS, infInertia, minNeigh, SelfAdj, SocialAdj, NumIter and SwarmSize to be obtained, which form the provisional total hyperparameter set I_{TOT,k1}.

After determining the provisional total PSOA hyperparameter set I_{TOT,k1}, a new sub-iteration k=k+1 is started (step S50′) and the method returns to step S20′. In detail, the determination of the calibration envelope signal portion EES_{ENV,p} is performed again through the provisional non-PSOA hyperparameter I_{Δt} just determined, and steps S20′-S50′ are therefore repeated using the provisional total hyperparameter set I_{TOT,k1} just determined.

If the stop condition is confirmed (i.e., if the estimate error F is lower than the threshold estimate error ε_{TH} or if the k number of sub-iterations performed is greater than the sub-iterations threshold number, output branch Y of step S40′), the provisional total hyperparameter set I_{TOT,k1} is considered optimized and therefore is suitably stored (step S55′) to be used for the subsequent execution of the offline TOF method 200_{A}, of the online TOF method or in general of the TOF method 170.

Steps S05′-S55′ of the offline TOF method 200_{A} are then repeated for the other values of actual distance D_{ACT}, so as to generate as many optimized total hyperparameter sets I_{TOT} which therefore make the PSOA and the determination of the calibration envelope signal portion EES_{ENV,p} optimized throughout the maximum variation range of the actual distance D_{ACT}.

Thereafter the offline TOF method 200_{A} ends.

With reference to FIG. 4B, the online TOF method (indicated in the Figure by the reference 200_{B}) is described, which allows the total hyperparameter sets I_{TOT} to be updated in real time while using the TOF device 100 as a meter.

While using the TOF device 100 as a meter, the target body T is placed at an unknown distance from the TOF device 100.

An iteration of the online TOF method 200_{B} is described hereinbelow that allows a part of the respective total hyperparameter set I_{TOT} to be updated. This iteration is based on a calibration electric echo signal EES indicative of a value of actual distance D_{ACT} that is unknown during the updating step of the total hyperparameter sets I_{TOT}.

The online TOF method 200_{B} may be reiterated a plurality of times, each time starting from a respective and different calibration electric echo signal EES indicative of a respective unknown value of calibration estimated distance D_{EST}, to update multiple total hyperparameter subsets I_{TOT} corresponding to respective ranges of actual distance D_{ACT}, so as to have the PSOA and the calibration envelope signal portion EES_{ENV,p} optimized throughout the maximum variation range of the actual distance D_{ACT}.

In detail, at each iteration, the online TOF method 200_{B} comprises performing sub-iterations (indicated by the index k in FIG. 4B).

At the first sub-iteration k=0 of the iteration considered, steps S05′-S30′ are performed based on the calibration electric echo signal EES considered, to determine a first value of the calibration estimated distance D_{EST}.

In particular, at the first sub-iteration k=0 of each iteration, steps S20′ and S25′ may be performed using the total hyperparameter set I_{TOT} generated through the offline TOF method 200_{A} and chosen, among the total hyperparameter sets I_{TOT} available, as a function of the first calibration TOF estimate t_{PREL} determined at step S20.

Furthermore, step S30′ may be omitted here.

The online TOF method 200_{B} further comprises determining the estimate error F as the error between the model A(ktₛ) and the calibration envelope signal portion EES_{ENV,p} calculated at the k-th sub-iteration (step S35B′). In particular, the estimate error F is determined through the error module 140 of the processing unit 110.

The online TOF method 200_{B} further comprises verifying the stop condition (step S40′). As previously described, the stop condition comprises verifying whether the estimate error F calculated at the k-th sub-iteration is lower than the threshold estimate error ε_{TH} or if the k number of sub-iterations performed is greater than the sub-iterations threshold number.

If the stop condition is not confirmed (i.e., if the estimate error F is greater than, or equal to, the threshold estimate error ε_{TH} and if the k number of sub-iterations performed is lower than, or equal to, the sub-iterations threshold number, output branch N of step S40′), an updated subset (or provisional subset) of total hyperparameters I_{TOT} is determined (step S45′), corresponding to the k-th sub-iteration and indicated in FIG. 4B by the reference I_{TOT,k2} (with I_{TOT,k2}=I_{PSOA,k2}+I_{Δt,k2}).

In particular, the updated subset of total hyperparameters I_{TOT,k2} is determined through the hyperparameter module 150. The determination of the updated subset of total hyperparameters I_{TOT,k2} occurs by minimizing the first objective function f₁ (here given by the error between the model A(ktₛ) and the calibration envelope signal portion EES_{ENV,p} calculated at the k-th sub-iteration) and the second objective function f₂ through the MODE algorithm. In detail, the use of the MODE in the online TOF method 200_{B} allows the values of the hyperparameters LowerBoundtPS, infInertia, NumIter to be updated, which form the updated subset of total hyperparameters I_{TOT,k2}.

After updating the subset of total hyperparameters I_{TOT,k2}, a new sub-iteration k=k+1 is started (step S50′) and the method returns to step S20′. In detail, the determination of the calibration envelope signal portion EES_{ENV,p} is performed again through the non-PSOA hyperparameter I_{Δt} just updated, and steps S20′-S50′ are therefore repeated using the updated set (or provisional set) of total hyperparameters I_{TOT,k2} (i.e., the set comprising the provisional subset of total hyperparameters I_{TOT,k2}, updated at the previous sub-iteration).

If the stop condition is confirmed (i.e., if the estimate error P is lower than the threshold estimate error ε_{TH} or if the k number of sub-iterations performed is greater than the sub-iterations threshold number, output branch Y of step S40′), the updated subset of total hyperparameters I_{TOT,k2} is considered optimized and therefore is suitably stored (step S55′) to be used for the subsequent execution of the online TOF method 200_{B} or the TOF method 170.

Steps S05′-S55′ of the online TOF method 200_{B} are then repeated for the other calibration electric echo signals EES, so as to update the total hyperparameter sets I_{TOT} throughout the maximum variation range of the actual distance D_{ACT}.

Thereafter the online TOF method 200_{B} ends.

Furthermore, the TOF method 170 (therefore possibly also the offline TOF method 200_{A} and/or the online TOF method 200_{B}) is implemented through suitable software instructions stored or accessible by the TOF device 100 and/or by suitable hardware/firmware of the TOF device 100.

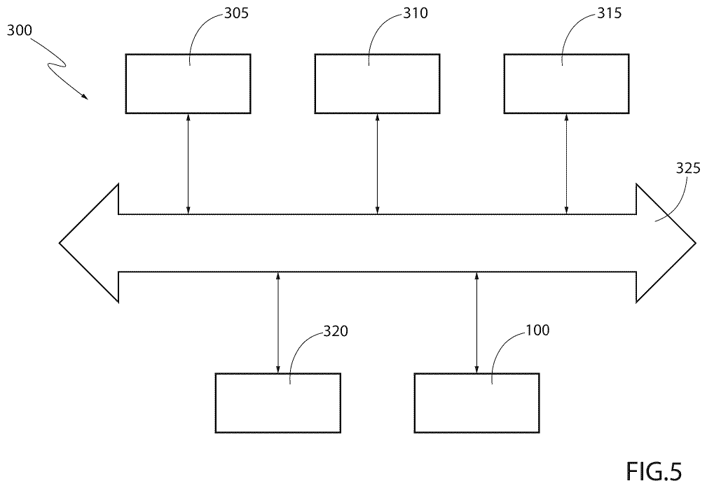

Referring now to FIG. 5, there is shown a simplified block diagram of an electronic system 300 comprising the TOF device 100 (or, similarly, a plurality thereof), according to an embodiment of the present disclosure.

In particular, the electronic system 300 is suitable for use in electronic apparatuses.

The electronic system 300 may comprise a controller 305 (for example, one or more microprocessors and/or one or more microcontrollers).

The electronic system 300 may further comprise an input/output device 310 (for example, a keyboard and/or a screen). The input/output device 310 may for example be used to generate and/or receive messages. The input/output device 310 may for example be configured to receive/provide a digital signal and/or an analog signal.

The electronic system 300 may further comprise a wireless interface 315 for exchanging messages with a wireless communication network (not shown), for example by means of radio frequency signals. Examples of wireless interface may include wireless antennas and transceivers.

The electronic system 300 may further comprise a power supply device (e.g., a battery 320) for powering the electronic system 300.

The electronic system 300 may also comprise one or more communication channels (bus) 325 to allow the exchange of data between the TOF device 100, the controller 305 (if any), the input/output device 310 (if any), the wireless interface 315 (if any) and the power supply device 320 (if any).

From an examination of the characteristics of the disclosure made according to the present disclosure the advantages that it affords are evident.

In particular, the TOF device 100 and the TOF method 170 allow an accurate determination of the measurement of the distance between the TOF device 100 and the target body T, with an uncertainty in the distance measurement which may be lower than about 1 mm.

This is achieved as the TOF device 100 exploits a first TOF estimate, raw and performed through a threshold-based model or cross-correlation estimator (CCE) model, to select the most suitable total hyperparameter set to determine the calibration envelope signal portion EES_{ENV,p} and to optimize the operation of the PSOA while determining the second (more accurate) TOF estimate.

The TOF device 100 is also inexpensive as it uses ultrasonic sensors to estimate the ToF, so it is not based on expensive optical solutions.

The TOF method 170 is also tolerant to echo shape distortion, i.e., it allows accurate TOF estimate of different types of echo shapes (e.g., noisy echo shapes, distorted echo shapes). Furthermore, the TOF method 170 has a self-adaptive behavior to the different signal acquisition conditions and allows the detection of multiple target bodies T.

The offline TOF method 200_{A} allows determining the total hyperparameter sets optimized as the distance between the TOF device 100 and the target body T varies, so as to increase the measurement accuracy in the maximum variation range of the distance to be measured (e.g., between about 35 cm and about 190 cm). This is obtained by reiterating the PSOA in a supervised manner (i.e., with the target body T at known distances) and comparing the estimated distance D_{EST} and the known actual distance D_{ACT} through a suitable measurement of the error.

The online TOF method 200_{B} allows improving the measurement accuracy even in highly variable measurement environmental conditions due to factors such as air temperature, humidity, air pressure, air turbulence and external noise, in general it takes into consideration of operating conditions other than those of production and initial verification. Indeed, the variability of these factors is not systematically considered during the offline TOF method 200_{A}. With the online TOF method 200_{B}, instead, deviations and uncertainties in the TOF estimate, due to these factors, may be further reduced. In particular, this further calibration and optimization of a part of the total hyperparameters may be performed at the request of the user or when the TOF device 100 automatically detects an offset between the measurement environmental conditions and the reference environmental conditions which is greater than a threshold offset. The remaining total hyperparameters are instead considered fixed as it has been verified that they are not significantly affected by variations in the measurement environmental conditions. The online TOF method 200_{B} is performed by reiterating the PSOA in an unsupervised manner (i.e., with the target body T at unknown distances) and comparing the envelope of the echo shape with the result of the envelope model through a suitable measurement of the error. As a result, the online TOF method 200_{B} allows a TOF estimate to be obtained that dynamically and automatically adjusts to different external conditions.

Furthermore, the TOF method 170 is based on the analysis of the envelope signal portion EES_{ENV,p} to the left of the maximum value of the envelope signal EES_{ENV}. This allows to disengage the modeling of the envelope from the right portion of the envelope signal EES_{ENV} and to concentrate on minimizing the error between the envelope model A(ktₛ) and the envelope signal portion EES_{ENV,p} which is actually indicative of the time-of-flight. This reduces computational costs and increases measurement accuracy.

Finally, it is clear that modifications and variations may be made to the disclosure described and illustrated herein without thereby departing from the scope of the present disclosure, as defined in the attached claims. For example, the different embodiments described may be combined with each other to provide further solutions.

Furthermore, with reference to FIGS. 4A and 4B, steps S05′-S55′ may be repeated several times for each range of actual distance D_{ACT}, for example by using, for each distance range, different calibration electric echo signals EES each indicative of a respective distance value belonging to the range considered.

Furthermore, more generally, the first TOF estimate τ_{PREL} is determined through known techniques which cause the first TOF estimate τ_{PREL} to have a first measurement accuracy value, while the second TOF estimate τ_{FIN} is determined through PSOA and has a second measurement accuracy value greater than the first measurement accuracy value. For example, the first measurement accuracy value corresponds to a distance uncertainty equal to, or greater than, about 3 mm, while the second accuracy value corresponds to a distance uncertainty equal to, or lower than, about 1 mm.

A method (170) to provide a time-of-flight, TOF, estimate, which elapses between the emission, by a TOF device (100), of an ultrasonic source signal (USS) and the reception, by the TOF device (100), of an ultrasonic echo signal (UES) returned by a target body (T) hit by the ultrasonic source signal (USS), the method may be summarized as including the steps of: a. generating (S05), by the TOF device (100), an electric echo signal (EES) indicative of the ultrasonic echo signal (UES) received; b. determining (S10), by the TOF device (100), an envelope signal (EES_{ENV}) indicative of an envelope of the electric echo signal (EES); c. generating (S15), by the TOF device (100), a first TOF estimate (τ_{PREL}) by processing the electric echo signal (EES), the first TOF estimate (τ_{PREL}) having a first measurement accuracy value; d. determining (S20), by the TOF device (100), an envelope signal portion (EES_{ENV,p}) of the envelope signal (EES_{ENV}), prior to a final time instant (t_{MAX}) corresponding to a maximum value of the envelope signal (EES_{ENV}), the determination of the envelope signal portion (EES_{ENV,p}) being performed using a non-PSOA hyperparameter (I_{Δt}) which is selected among a plurality of non-PSOA hyperparameters (I_{Δt}) as a function of the first TOF estimate (τ_{PREL}); and e. generating (S25), by the TOF device (100), a second TOF estimate (τ_{FIN}) by processing the envelope signal portion (EES_{ENV,p}) by means of a Particle Swarm Optimization Algorithm, PSOA, the second TOF estimate (τ_{FIN}) having a second measurement accuracy value greater than the first measurement accuracy value, the PSOA being optimized based on a PSOA hyperparameter set (I_{PSOA}) which is selected among a plurality of PSOA hyperparameter sets (I_{PSOA}) as a function of the first TOF estimate (τ_{PREL}), wherein said time-of-flight estimate is the second TOF estimate (τ_{FIN}).

The step of generating (S20) the first TOF estimate (τ_{PREL}) may include processing the envelope signal portion (EES_{ENV,p}) through a threshold-based model or a cross-correlation estimator model.

The envelope signal portion (EES_{ENV,p}) may be between an initial time instant (t0) and the final time instant (t_{MAX}), wherein the final time instant (t_{MAX}) corresponds to the maximum value of the envelope signal (EES_{ENV}), and the initial time instant (t0) may be determined as a function of the selected non-PSOA hyperparameter (I_{Δt}) and the final time instant (t_{MAX}).

Each non-PSOA hyperparameter (I_{Δt}) may be a first hyperparameter (LowerBoundtPS) indicative of a time length of the envelope signal portion (EES_{ENV,p}), and each PSOA hyperparameter set (I_{PSOA}) may include: a second hyperparameter (infInertia) indicative of a lower limit of the range of PSOA particle swarm adaptive inertia; a third hyperparameter (minNeigh) indicative of a minimum dimension of the PSOA adaptive neighbor; a fourth hyperparameter (SelfAdj) indicative of a best position weighting level of each PSOA particle during a speed regulation of the PSOA particles; a fifth hyperparameter (SocialAdj) indicative of a best particle contribution in the PSOA adaptive neighbor considered during the PSOA particle speed regulation; a sixth hyperparameter (NumIter) indicative of an iteration number of the PSOA; a seventh hyperparameter (SwarmSize) indicative of a particle total number of the particle swarm.

The method may further include the step of determining (S30), by the TOF device (100), an estimated distance (D_{EST}) as a function of the second TOF estimate (τ_{FIN}).

Each non-PSOA hyperparameter (I_{Δt}) and each PSOA hyperparameter set (I_{PSOA}) may be associated with a respective range of actual distance (D_{ACT}) between the TOF device (100) and the target body (T), the ranges of actual distance (D_{ACT}) being consecutive and continuous with each other and together forming a maximum variation range of the actual distance (D_{ACT}).

The method may further include performing a plurality of sub-iterations (k), each sub-iteration (k) including the steps of: f. acquiring (S05′), by the TOF device (100), a plurality of calibration electric echo signals (EES) indicative of respective values of actual distance (D_{ACT}), each value of actual distance (D_{ACT}) being in a respective range of actual distance (D_{ACT}) of said ranges of actual distance (D_{ACT}); g. determining (S10′), by the TOF device (100) and for each calibration electric echo signal (EES), a respective calibration envelope signal (EES_{ENV}) indicative of an envelope of the calibration electric echo signal (EES); h. generating (S15′), by the TOF device (100) and for each calibration electric echo signal (EES), a respective first calibration TOF estimate (τ_{PREL}) by processing the respective calibration electric echo signal (EES), the first calibration TOF estimate (τ_{PREL}) having a respective first calibration measurement accuracy value; i. determining (S20′), by the TOF device (100) and for each calibration envelope signal (EES_{ENV}), a respective calibration envelope signal portion (EES_{ENV,p}) of the calibration envelope signal (EES_{ENV}), prior to a final time instant (t_{MAX}) corresponding to a maximum value of the calibration envelope signal (EES_{ENV}), the determination of the calibration envelope signal portion (EES_{ENV,p}) being performed using a respective provisional non-PSOA hyperparameter (I_{Δt,k1}; I_{Δt,k2}); j. generating (S25′), by the TOF device (100) and for each calibration envelope signal portion (EES_{ENV,p}), a respective second calibration TOF estimate (τ_{FIN}) by processing the calibration envelope signal portion (EES_{ENV,p}) by means of the PSOA, the second calibration TOF estimate (τ_{FIN}) having a respective second calibration measurement accuracy value greater than the first calibration measurement accuracy value, the PSOA being configured based on a respective provisional PSOA hyperparameter set (I_{PSOA,k1}; I_{PSOA,k2}); k. determining (S35A′; S35B′), by the TOF device (100) and for each second calibration TOF estimate (τ_{FIN}), a respective estimate error (ε); 1. updating (S40′-S50′), by the TOF device (100) and for each estimate error (ε), the provisional non-PSOA hyperparameter (I_{Δt,k1}; I_{Δt,k2}) and the provisional PSOA hyperparameter set (I_{PSOA,k1}; I_{PSOA,k2}) as long as the estimate error (ε) is greater than, or equal to, a threshold estimate error (ε_{TH}) and the number of sub-iterations performed is lower than, or equal to, a sub-iterations threshold number; and m. storing (S55′), by the TOF device (100) and for each estimate error (ε), the provisional non-PSOA hyperparameter (I_{Δt,k1}; I_{Δt,k2}) and the provisional PSOA hyperparameter set (I_{PSOA,k1}; I_{PSOA,k2}) as the non-PSOA hyperparameter (I_{Δt}) and, respectively, the PSOA hyperparameter set (I_{PSOA}) if the estimate error (ε) is lower than the threshold estimate error (ε_{TH}) or if the number of sub-iterations performed is greater than the sub-iterations threshold number.

At each sub-iteration, the step of determining (S20′) the calibration envelope signal portion (EES_{ENV,p}) may be based on the use of the provisional non-PSOA hyperparameter (I_{Δt,k1}; I_{Δt,k2}) updated at the immediately preceding sub-iteration and the step of generating (S25′) the second calibration TOF estimate (τ_{FIN}) may be based on the use of the provisional PSOA hyperparameter set (I_{PSOA,k1}; I_{PSOA,k2}) updated at the immediately preceding sub-iteration, and, at each sub-iteration, the step of updating (S40′-S50′) the provisional non-PSOA hyperparameter (I_{Δt,k1}; I_{Δt,k2}) and the provisional PSOA hyperparameter set (I_{PSOA,k1}; I_{PSOA,k2}) may include: verifying (S40′) whether the estimate error (ε) calculated at the current sub-iteration is lower than the threshold estimate error (ε_{TH}) and whether the number of sub-iterations performed is greater than the sub-iterations threshold number; and if the estimate error (ε) calculated at the current sub-iteration is greater than, or equal to, the threshold estimate error (ε_{TH}) and if the number of sub-iterations performed is lower than, or equal to, the sub-iterations threshold number, determining (S45′) the provisional non-PSOA hyperparameter (I_{Δt,k1}; I_{Δt,k2}) and the provisional PSOA hyperparameter set (I_{PSOA,k1}; I_{PSOA,k2}) of the current sub-iteration through a Multi-Objective Differential Evolution, MODE, algorithm.

The step of determining (S45′) the provisional non-PSOA hyperparameter (I_{Δt,k1}; I_{Δt,k2}) and the provisional PSOA hyperparameter set (I_{PSOA,k1}; I_{PSOA,k2}) may include minimizing, through the MODE, a first objective function (f₁) and a second objective function (f₂), the first objective function (f₁) depending on the estimate error (ε) and the second objective function (f₂) depending on a sum of the sixth hyperparameter (NumIter) and the seventh hyperparameter (SwarmSize).

The method may further include the steps of: acquiring the values of the actual distance (D_{ACT}), known and associated with the calibration electric echo signals (EES); and determining (S30′), by the TOF device (100) and for each second calibration TOF estimate (τ_{FIN}), a respective calibration estimated distance (D_{EST}) as a function of the second calibration TOF estimate (τ_{FIN}), wherein the step of determining (S35A′) the estimate error (ε) may include calculating an error between the calibration estimated distance (D_{EST}) and the respective actual distance (D_{ACT}).

The step of determining (S45′) the provisional non-PSOA hyperparameter (I_{Δt,k1}) and the provisional PSOA hyperparameter set (I_{PSOA,k1}) may include determining the first hyperparameter (LowerBoundtPS), the second hyperparameter (infInertia), the third hyperparameter (minNeigh), the fourth hyperparameter (SelfAdj), the fifth hyperparameter (SocialAdj), the sixth hyperparameter (NumIter) and the seventh hyperparameter (SwarmSize).

The step of determining (S35B′) the estimate error (ε) may include calculating an error between the envelope signal portion (EES_{ENV,p}) and a modeling function (A(ktₛ)) of the envelope signal portion (EES_{ENV,p}).

The step of determining (S45′) the provisional non-PSOA hyperparameter (I_{Δt,k2}) and the provisional PSOA hyperparameter set (I_{PSOA,k2}) may include updating the values of the first hyperparameter (LowerBoundtPS), the second hyperparameter (infInertia) and of the sixth hyperparameter (NumIter).

A computer program product may be summarized as including as one storable in a TOF device (100), the computer program being designed such that, when executed, the TOF device (100) becomes configured to execute a method to provide a time-of-flight, TOF, estimate.

A TOF device (100) to provide a time-of-flight, TOF, estimate which elapses between the emission, by an ultrasonic transducer (105) of the TOF device (100), of an ultrasonic source signal (USS) and the reception, by the ultrasonic transducer (105) of the TOF device (100), of an ultrasonic echo signal (UES) returned by a target body (T) hit by the ultrasonic source signal (USS), the TOF device (100) may be further summarized as including a processing unit (110) electrically coupled to the ultrasonic transducer (105) and configured to: a. generate (S05) an electric echo signal (EES) indicative of the ultrasonic echo signal (UES) received; b. determine (S10) an envelope signal (EES_{ENV}) indicative of an envelope of the electric echo signal (EES); c. generate (S15) a first TOF estimate (τ_{PREL}) by processing the electric echo signal (EES), the first TOF estimate (τ_{PREL}) having a first measurement accuracy value; d. determine (S20) an envelope signal portion (EES_{ENV,p}) of the envelope signal (EES_{ENV}), prior to a final time instant (t_{MAX}) corresponding to a maximum value of the envelope signal (EES_{ENV}), the determination of the envelope signal portion (EES_{ENV,p}) being performed using a non-PSOA hyperparameter (I_{Δt}) which is selected among a plurality of non-PSOA hyperparameters (I_{Δt}) as a function of the first TOF estimate (τ_{PREL}); and e. generate (S25) a second TOF estimate (τ_{FIN}) by processing the envelope signal portion (EES_{ENV,p}) by means of a Particle Swarm Optimization Algorithm, PSOA, the second TOF estimate (τ_{FIN}) having a second measurement accuracy value greater than the first measurement accuracy value, the PSOA being optimized based on a PSOA hyperparameter set (I_{PSOA}) which is selected among a plurality of PSOA hyperparameter sets (I_{PSOA}) as a function of the first TOF estimate (τ_{PREL}), wherein said time-of-flight estimate is the second TOF estimate (τ_{FIN}).

An electronic system (300) may be summarized as including a TOF device (100) according to claim 15.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method to provide a time-of-flight, TOF, estimate, which elapses between the emission, by a TOF device, of an ultrasonic source signal and the reception, by the TOF device, of an ultrasonic echo signal returned by a target body hit by the ultrasonic source signal, the method comprising:
generating, by the TOF device, an electric echo signal indicative of the ultrasonic echo signal received;
determining, by the TOF device, an envelope signal indicative of an envelope of the electric echo signal;
generating, by the TOF device, a first TOF estimate by processing the electric echo signal, the first TOF estimate having a first measurement accuracy value;
determining, by the TOF device, an envelope signal portion of the envelope signal, prior to a final time instant corresponding to a maximum value of the envelope signal, the determination of the envelope signal portion being performed using a non-PSOA hyperparameter which is selected among a plurality of non-PSOA hyperparameters as a function of the first TOF estimate; and
generating, by the TOF device, a second TOF estimate by processing the envelope signal portion by means of a Particle Swarm Optimization Algorithm, PSOA, the second TOF estimate having a second measurement accuracy value greater than the first measurement accuracy value, the PSOA being optimized based on a PSOA hyperparameter set which is selected among a plurality of PSOA hyperparameter sets as a function of the first TOF estimate,
wherein said time-of-flight estimate is the second TOF estimate.

2. The method according to claim 1, wherein the generating the first TOF estimate comprises processing the envelope signal portion through a threshold-based model or a cross-correlation estimator model.

3. The method according to claim 1, wherein the envelope signal portion is comprised between an initial time instant and the final time instant,
wherein the final time instant corresponds to the maximum value of the envelope signal, and
wherein the initial time instant is determined as a function of the selected non-PSOA hyperparameter and the final time instant.

4. The method according to claim 1, wherein each non-PSOA hyperparameter is a first hyperparameter indicative of a time length of the envelope signal portion, and
wherein each PSOA hyperparameter set comprises:
a second hyperparameter indicative of a lower limit of the range of PSOA particle swarm adaptive inertia;
a third hyperparameter indicative of a minimum dimension of the PSOA adaptive neighbor;
a fourth hyperparameter indicative of a best position weighting level of each PSOA particle during a speed regulation of the PSOA particles;
a fifth hyperparameter indicative of a best particle contribution in the PSOA adaptive neighbor considered during the PSOA particle speed regulation;
a sixth hyperparameter indicative of an iteration number of the PSOA;
a seventh hyperparameter indicative of a particle total number of the particle swarm.

5. The method according to claim 1, further comprising the determining, by the TOF device, an estimated distance as a function of the second TOF estimate.

6. The method according to claim 1, wherein each non-PSOA hyperparameter and each PSOA hyperparameter set are associated with a respective range of actual distance between the TOF device and the target body, the ranges of actual distance being consecutive and continuous with each other and together forming a maximum variation range of the actual distance.

7. The method according to claim 6, further comprising performing a plurality of sub-iterations, each sub-iteration comprising:
acquiring, by the TOF device, a plurality of calibration electric echo signals indicative of respective values of actual distance, each value of actual distance being comprised in a respective range of actual distance of said ranges of actual distance;
determining, by the TOF device and for each calibration electric echo signal, a respective calibration envelope signal indicative of an envelope of the calibration electric echo signal;
generating, by the TOF device and for each calibration electric echo signal, a respective first calibration TOF estimate by processing the respective calibration electric echo signal, the first calibration TOF estimate having a respective first calibration measurement accuracy value;
determining, by the TOF device and for each calibration envelope signal, a respective calibration envelope signal portion of the calibration envelope signal, prior to a final time instant corresponding to a maximum value of the calibration envelope signal, the determination of the calibration envelope signal portion being performed using a respective provisional non-PSOA hyperparameter;
generating, by the TOF device and for each calibration envelope signal portion, a respective second calibration TOF estimate by processing the calibration envelope signal portion by means of the PSOA, the second calibration TOF estimate having a respective second calibration measurement accuracy value greater than the first calibration measurement accuracy value, the PSOA being configured based on a respective provisional PSOA hyperparameter set;
determining, by the TOF device and for each second calibration TOF estimate, a respective estimate error;
updating, by the TOF device and for each estimate error, the provisional non-PSOA hyperparameter and the provisional PSOA hyperparameter set as long as the estimate error is greater than, or equal to, a threshold estimate error and the number of sub-iterations performed is lower than, or equal to, a sub-iterations threshold number; and
storing, by the TOF device and for each estimate error, the provisional non-PSOA hyperparameter and the provisional PSOA hyperparameter set as the non-PSOA hyperparameter and, respectively, the PSOA hyperparameter set if the estimate error is lower than the threshold estimate error or if the number of sub-iterations performed is greater than the sub-iterations threshold number.

8. The method according to claim 7, wherein, at each sub-iteration, the determining the calibration envelope signal portion is based on the use of the provisional non-PSOA hyperparameter updated at the immediately preceding sub-iteration and the generating the second calibration TOF estimate is based on the use of the provisional PSOA hyperparameter set updated at the immediately preceding sub-iteration, and
wherein, at each sub-iteration, the updating the provisional non-PSOA hyperparameter and the provisional PSOA hyperparameter set comprises:
verifying whether the estimate error calculated at the current sub-iteration is lower than the threshold estimate error and whether the number of sub-iterations performed is greater than the sub-iterations threshold number; and
if the estimate error calculated at the current sub-iteration is greater than, or equal to, the threshold estimate error and if the number of sub-iterations performed is lower than, or equal to, the sub-iterations threshold number, determining the provisional non-PSOA hyperparameter and the provisional PSOA hyperparameter set of the current sub-iteration through a Multi-Objective Differential Evolution, MODE, algorithm.

9. The method according to claim 4, wherein the determining the provisional non-PSOA hyperparameter and the provisional PSOA hyperparameter set comprises minimizing, through the MODE, a first objective function and a second objective function, the first objective function depending on the estimate error and the second objective function depending on a sum of the sixth hyperparameter and the seventh hyperparameter.

10. The method according to claim 7, further comprising the steps of:
acquiring the values of the actual distance, known and associated with the calibration electric echo signals; and
determining, by the TOF device and for each second calibration TOF estimate, a respective calibration estimated distance as a function of the second calibration TOF estimate,
wherein the determining the estimate error comprises calculating an error between the calibration estimated distance and the respective actual distance.

11. The method according to claim 9, wherein the determining the provisional non-PSOA hyperparameter and the provisional PSOA hyperparameter set comprises determining the first hyperparameter, the second hyperparameter, the third hyperparameter, the fourth hyperparameter, the fifth hyperparameter, the sixth hyperparameter and the seventh hyperparameter.

12. The method according to claim 7, wherein the determining the estimate error comprises calculating an error between the envelope signal portion and a modeling function of the envelope signal portion.

13. The method according to claim 9, wherein the determining the provisional non-PSOA hyperparameter and the provisional PSOA hyperparameter set comprises updating the values of the first hyperparameter, the second hyperparameter and of the sixth hyperparameter.

14. A TOF device to provide a time-of-flight, TOF, estimate which elapses between the emission, by an ultrasonic transducer of the TOF device, of an ultrasonic source signal and the reception, by the ultrasonic transducer of the TOF device, of an ultrasonic echo signal returned by a target body hit by the ultrasonic source signal,
the TOF device further comprising a processing unit electrically coupled to the ultrasonic transducer and configured to:
generate an electric echo signal indicative of the ultrasonic echo signal received;
determine an envelope signal indicative of an envelope of the electric echo signal;
generate a first TOF estimate by processing the electric echo signal, the first TOF estimate having a first measurement accuracy value;
determine an envelope signal portion of the envelope signal, prior to a final time instant corresponding to a maximum value of the envelope signal, the determination of the envelope signal portion being performed using a non-PSOA hyperparameter which is selected among a plurality of non-PSOA hyperparameters as a function of the first TOF estimate; and
generate a second TOF estimate by processing the envelope signal portion by means of a Particle Swarm Optimization Algorithm, PSOA, the second TOF estimate having a second measurement accuracy value greater than the first measurement accuracy value, the PSOA being optimized based on a PSOA hyperparameter set which is selected among a plurality of PSOA hyperparameter sets as a function of the first TOF estimate,
wherein said time-of-flight estimate is the second TOF estimate.

15. The TOF device of claim 14 wherein first TOF estimate comprises processing the envelope signal portion through a threshold-based model or a cross-correlation estimator model.

16. A method, comprising:
providing a time-of-flight, TOF, estimate, which elapses between an emission, by a TOF device, of an ultrasonic source signal and a reception, by the TOF device, of an ultrasonic echo signal returned by a target body hit by the ultrasonic source signal, by:
generating, by the TOF device, an electric echo signal indicative of the ultrasonic echo signal received;
determining, by the TOF device, an envelope signal indicative of an envelope of the electric echo signal;
generating, by the TOF device, a first TOF estimate by processing the electric echo signal, the first TOF estimate having a first measurement accuracy value;
determining, by the TOF device, an envelope signal portion of the envelope signal, prior to a final time instant corresponding to a maximum value of the envelope signal, the determination of the envelope signal portion being performed using a non-PSOA hyperparameter which is selected among a plurality of non-PSOA hyperparameters as a function of the first TOF estimate.

17. The method of claim 16, comprising generating, by the TOF device, a second TOF estimate by processing the envelope signal portion by means of a Particle Swarm Optimization Algorithm, PSOA.

18. The method of claim 17 wherein the second TOF estimate has a second measurement accuracy value greater than the first measurement accuracy value, the PSOA being optimized based on a PSOA hyperparameter set which is selected among a plurality of PSOA hyperparameter sets as a function of the first TOF estimate.

19. The method of claim 18 wherein the time-of-flight estimate is the second TOF estimate.
